(19) United States
(12) Patent Application Publication
(10) Pub. No.: US 2021/0375541 A1
(43) Pub. Date: Dec. 2, 2021

(54) ELECTRICAL MACHINE AND METHOD FOR FABRICATION OF A COIL OF AN ELECTRICAL MACHINE

(71) Applicants: Siemens Gamesa Renewable Energy A/S, Brande (DK); Siemens Aktiengesellschaft, München (DE)

(72) Inventors: Markus Klöpzig, Ebermannstadt (DE); Erik Groendahl, Them (DK); Marijn Pieter Oomen, Erlangen (DE); Arwyn Thomas, Cheshire (GB)

(21) Appl. No.: 17/290,893

(22) PCT Filed: Oct. 30, 2019
(86) PCT No.: PCT/EP2019/079592

§ 371 Date: May 3, 2021

(30) Foreign Application Priority Data
Nov. 5, 2018 (EP) 18204441.2

(51) Int. Cl. H01F 41/04; H02K 3/02; H02K 3/28; H02K 55/02

(52) U.S. Cl. CPC H01F 41/048; H02K 3/02; H02K 2213/03; H02K 55/02; H02K 3/28

(57) ABSTRACT

Provided is an electrical machine including a rotor and a stator with at least one coil, wherein the coil includes one or more windings of one or more tape-shaped conductors wherein the or each conductor has a longitudinal axis, wherein the coil includes two opposing straight sections and two opposing arc-shaped coil head sections, wherein the coil includes at least two torsion sections, in which the or each winding is twisted around the longitudinal axis of the or each conductor, so that a width direction of the one or each conductors in at least one of the straight sections is parallel or essentially parallel to a direction of a magnetic field generated or generatable by the rotor penetrating the at least one straight section.

### CROSS-REFERENCE TO RELATED APPLICATIONS

This application claims priority to PCT Application No. PCT/EP2019/079592, having a filing date of Oct. 30, 2019, which is based off of EP Application No.18204441.2, having a filing date of Nov. 5, 2018, the entire contents both of which are hereby incorporated by reference.

### FIELD OF TECHNOLOGY

The following relates to an electrical machine comprising a rotor and a stator with at least one coil, wherein the coil comprises one or more windings of one or more tape-shaped conductors, wherein the or each conductor has a longitudinal axis, wherein the coil comprises two opposing straight sections and two opposing arc-shaped coil head sections. Additionally, the following relates to a method for fabrication of a coil of an electrical machine.

### BACKGROUND

Electrical machines used as motors or generators usually comprise copper windings in the stator and/or the rotor. These copper windings generate large amounts of resistive power loss, which decreases the efficiency of the electrical machine. For an improved efficiency, the constant magnet field of the rotor can alternatively be produced by permanent magnets or by superconductor windings. However, in the stator, the usage of permanent magnets is not possible. The usage of superconductors in the stator of an electrical machine is known in the state of the art.

In EP 3 291 429 A1, a synchronous generator for wind turbines is disclosed. The generator comprises a rotor and a stator, wherein the stator comprises a plurality of induction coils of a high-temperature superconducting material arranged to generate the magnetic field. The use of a superconducting stator instead of a superconducting rotor allows simplifying the refrigeration system used for cooling of the superconductors.

In CN 203734486 U, a high-temperature superconducting permanent magnet wind power generator with a double stator structure is described. The inner and outer walls of the rotor are circumferentially spaced and bear permanent magnets, which are separated by an air gap from an inner and outer stator.

CN 106059126 A discloses a stator of a high-temperature superconducting induction motor, wherein the stator comprises a stator core and a racetrack-shaped superconducting stator coil, which is fixed in a groove of the stator core.

In CN 101771331 B, a transverse flux superconducting synchronous motor is disclosed. As stator coils, superconducting armature windings with a racetrack-shape are used. The armature windings are arranged on a support frame, which is mounted inside a cryogenic shield container.

During operation of the electrical machine, the windings in the stator are subject to an alternating magnetic field and carry an alternating current. In these conditions, also superconducting windings may generate some power loss, also known as “AC loss”, which includes for instance losses due to a magnetization hysteresis of the superconductor. In superconductor windings, such a power loss is smaller than in copper windings, but the heat generated due to this power loss has to be removed from the cryogenic environment of the superconductors. Therefore, this AC loss may present a problem also in superconducting windings.

### SUMMARY

An aspect relates to provide an electrical machine with a reduced occurrence of power loss in the stator windings and therefore with an improved efficiency.

According to embodiments of the invention, this aspect is achieved by an electrical machine as initially described, wherein the coil comprises at least two torsion sections, in which the or each winding is twisted around the longitudinal axis of the or each conductor, so that a width direction of the one or each conductor in at least one of the straight sections is parallel or essentially parallel to a direction of a magnetic field generated or generatable by the rotor penetrating the at least one straight section.

The coil comprises one or more windings of one or more tape-shaped conductors. The coil exhibits two arc-shaped coil head sections and two straight sections, so that the coil forms a race-track shape. The or each tape-shaped conductor extends along a longitudinal axis, wherein the longitudinal axis of a wound conductor forming one or more windings follows the shape of the one or more windings. The at least one coil of the stator of the electrical machine is subject to a magnetic field generated or generatable by the rotor of the electrical machine. The magnetic field at each stator coil is mostly determined by the amount and the distribution of magnetic material like iron in a stator core of the stator. Due to the influence of the stator core, the magnetic field is not a rotating field vector that rotates around the rotational axis for the rotor.

Instead, in the vicinity of the stator coils, it is close to a sinusoidally varying field, whose magnetic field strength varies between the maximum value Bₘₐₓ and the minimum value Bₘᵢₙ, wherein Bₘᵢₙ can be -Bₘₐₓ. Besides the varying value, the direction of the magnetic field remains almost constant, so that the stator coil is subject to a magnetic field with a sinusoidally varying field strength, but with a constant or almost constant direction.

The straight sections of the coil extend in axial direction of the electrical machine and are for instance parallel or essentially parallel to an air gap between the rotor and the stator. Therefore, the amount of conductor material in the straight sections of the coil can exceed the amount of conductor material in the coil head sections. Furthermore, the straight sections of the coil are in close contact to the stator core, for instant to pole sections of the stator core, so that the largest amount of power loss occurs in the straight sections of the coils.

In a tape-shaped conductor, for instance in a tape-shaped high-temperature superconductor, an alternating magnetic field component perpendicular to a width of the conductor causes large AC loss due to a magnetization of the conductor and its hysteresis. Similar to eddy current losses in copper coils, also the AC loss in a superconducting coil scales with the width of the tape-shaped conductor as well as with the amplitude of the magnetic field perpendicular to the width.

The AC loss occurring in one of the straight sections of the coil depends on an extent of the conductor in the direction perpendicular of the magnetic field. Hence, a larger extent of the tape-shaped conductor orthogonal to the magnetic field causes larger AC losses. Since the width of a tape-shaped conductor is much larger than its thickness, the largest losses in a tape-shaped conductor occur if the width direction of the conductor is orthogonal to the magnetic field. Consequently, the least amount of AC losses occurs, if the thickness direction of the tape-shaped conductor is orthogonal to the magnetic field or if the width direction is parallel to the magnetic field, respectively.

By providing the at least two torsion sections of the coil, it is possible to twist the or each winding around the longitudinal axis of the or each conductor forming the windings. By the twisting, the width direction of the conductors in at least one of the straight sections can be aligned parallel or essentially parallel to the direction of the magnetic field, so that loss like AC loss or eddy currents in the at least one straight section of the coil can be reduced advantageously.

Additionally, due to the reduced loss, the usage of tape-shaped superconductors, in particular tape-shaped high-temperature superconductors, for the coil is advantageously possible since a reduced AC loss also reduces heat generation in the stator coils which significantly facilitates a cooling of the superconducting coils to their operation temperature of for instance 30 to 70 Kelvin. Due to the reduced heat, a smaller and/or simpler and more efficient design of the cooling means used for cooling of the electrical machine can be used enabling the usage of a larger amount of electrically insulating material in and/or around the stator. Also, a coil with a specified number of windings needs less of a high-temperature superconducting material, since with a reduced field perpendicular to the one or each tape-shaped conductor, an effective current or a critical current, respectively, of the one or each conductor can be higher. The usage of less high-temperature superconducting material for a coil reduces the size of the coil as well as its costs and the effort of the coil fabrication.

The tape-shaped conductors can have for instance a width in the order of several millimeters and a thickness in the order of several micrometers, so that by aligning the or each conductor in such manner that the width direction is parallel or essentially parallel to the magnetic field vector, an AC loss can be reduced by a factor in the order of 1000 in case of a parallel alignment. Also, in case of an essentially parallel alignment, in which there is for instance a deviation of a few degrees between the width direction of the tape-shaped conductor in the straight section or a portion of the straight section, respectively, and the direction of the magnetic field, still a large reduction of the AC loss in the conductors of the windings can be achieved.

The magnetic field generated or generatable by the rotor can be determined for instance by calculation and/or by measurement. A calculation can be for instance a simulation considering the geometry, the materials and the material distribution of the rotor, the stator and/or further components of the electrical machine. Based on the calculated and/or measured magnetic field, a direction of the magnetic field penetrating each straight section can be determined and the or each conductor of the respective straight section can be aligned using the torsion sections.

In an embodiment of the invention, the coil may comprise four torsion sections, which are each arranged between one of the coil head sections and one of the straight sections. By providing four torsion sections each arranged between one of the coil head sections and one of the straight sections, the conductor or the conductors within both straight sections can be twisted. Additionally, the one or each winding can be twisted around different twisting angles in each of the straight sections. This is advantageous, since both straight sections can each have a different twist angle compared to each coil head section and/or compared to the respective other straight section. As a consequence, the one or each winding in the straight sections can be aligned to the direction of the magnetic field penetrating the respective straight section. In the coil head sections, which may protrude from a stator core, the occurrence of AC loss is reduced due to the distance of the coil head sections from the stator core, so that an alignment of the coil head sections is not necessary.

The width direction of the one or each tape-shaped conductor in the coil head sections is parallel or essentially parallel to a bending axis of the respective coil head section. Hence, the width direction of the one or each tape-shaped-conductor and the bending axis are both orthogonal to the plane in which the coil lies. The width direction is also orthogonal to the longitudinal axis of the tape-shaped conductor or the winding axis of the coil, respectively. By arranging the or each tape-shaped conductor in the coil head section with its width direction parallel to a bending axis of the respective coil head section, a bending of the conductor for forming the arc-shaped coil head sections during a fabrication of the coil can be facilitated since the one or each conductor is bent over its width direction with a constant radius. This can for instance reduce the occurrence of unwanted shear forces during a bending process.

In an embodiment of the invention, a twist angle in each torsion section may be ±90° or less. A maximum twist angle of ±90° in a torsion section is sufficient to enable all orientations of the straight sections compared to the coil head sections and/or to enable a parallel or essentially parallel alignment of the width direction of the one or each conductor in the straight sections to the magnetic field penetrating the respective straight section.

In an embodiment of the invention, the coil may comprise a plurality of windings, wherein each winding abuts at least one neighbouring winding or wherein an insulating layer is disposed between neighbouring windings. The plurality of windings, or turns, respectively, of the coil can be insulated either by introducing an insulating layer between the one or each conductor forming the two neighbouring windings. It is also possible that each winding abuts at least one neighbouring winding, wherein for instance the one or each conductor forming the two neighbouring windings comprises an insulating layer or an insulating coating around its outer circumference, so that the windings of the coil are insulated against each other. An insulating layer between two neighbouring windings can be bent in the coil head sections and twisted in the torsion sections accordingly to the one or each conductor.

The coil comprises a plurality of windings and at least one transposition section, in which a stacking order of the windings is changed. For coils with a plurality of windings, an electrical transposition of the windings may be needed to decouple the windings. Such a transposition or decoupling can be provided by a transposition section of the coil, in which the stacking order of the windings is changed. Such an electrical transposition can be used for instance to reduce the resistance of the coil for guiding of alternating current. The change of the stacking order of the tape-shaped conductors can occur for instance like in a Roebel cable, especially like in a high temperature superconducting Roebel cable comprising a plurality of tape-shaped superconductors. Advantageously, by providing at least one transposition region, coupling currents and losses in the transmission of alternating currents can be reduced. In particular, the stacking order or the windings forming the coil can be changed cyclically. A transposition section can be arranged for instance in a coil head section, in a torsion section or in a straight section of the coil.

In an embodiment of the invention, the one or each conductor is a superconductor, in particular a high-temperature superconductor of the first generation or the second generation. Thereby, a high-temperature superconductor of the first generation can comprise a plurality of superconducting filaments, wherein the high-temperature superconductor of the second generation may comprise a metal tape coated by a superconducting ceramic material. Especially, a high-temperature superconductor of the second generation can have a large aspect ratio or a large ratio between its width and its thickness, respectively, so that the effect of reducing the AC loss by the torsion sections is greatest by using a high-temperature superconductor of the second generation. However, also a high-temperature superconductor of the first generation may exhibit a tape-shape and a width, which exceeds the thickness by a factor of 10 to 25, so that the provision of the torsion sections is also advantageous. A super-conductor of the second generation can be a so-called “coated conductor” with a thin, for instance 2 μm thick, superconducting ceramic layer on a much thicker, for instance 100 μm thick, metal substrate tape.

The or each conductor is a coated conductor comprising a coating layer and a superconducting layer, in particular a superconducting layer made of YBaCuO, or that the conductor comprises superconducting filaments, in particular filaments made of BiSrCaCuO, or that the conductor comprises a layer and/or at least one strand of MgB₂ and/or NbTi and/or Nb₃Sn. Besides YBaCuO, also other second generation high-temperature superconductors with a rare-earth material other than Yttrium can be used.

In an embodiment of the invention, the rotor may comprise at least one superconducting element, especially a superconducting element for the generation of the magnetic field. Providing both a stator and a rotor with superconducting elements or superconducting coils, respectively, has the advantage that a cooling of both the rotor and the stator can be facilitated, since synergetic effects in the cooling can be used. Such synergetic effects can comprise a mutual thermal insulation of the rotor and the stator and/or a mutual use of cooling components and/or coolant.

The electrical machine can be a synchronous machine or an induction machine. The electrical machine can comprise an inner rotor and an outer stator or an inner stator and an outer rotor. In case of a stator with coils made from a superconducting material, the electrical machine can comprise cooling means for cooling of the stator and/or the stator coils. The electrical machine can be a high-power machine used as a generator in a wind turbine or as a motor in a ship.

A method according to embodiments of the invention for fabrication of a coil of an electric machine according to embodiments of the invention comprises the steps:

a) providing one or more tape-shaped conductors,
b) twisting the one or each tape-shaped conductor, wherein a twist angle is determined in dependence of a calculated and/or a measured magnetic field of the rotor,
c) forming of a plurality of windings from the one or more tape-shaped conductors,
d) arranging of the windings forming a coil,
wherein the steps are conducted in the order a), b), c), d), or a), c), b) d), or a), c), d), b).

As a first step, one or more tape-shaped conductors are provided. After provision of the one or more tape-shaped conductors, in a first embodiment of the method for fabrication of the coil, it is possible that the one or more tape-shaped conductors are twisted, wherein the twist angle is determined in dependence of a calculated and/or a measured magnetic field of the rotor. Thereby, the twisting of the one or each tape-shaped conductor occurs in at least two torsion sections of the one or each tape-shaped conductor in such manner that the one or each tape-shaped conductor is aligned with its width direction parallel to the magnetic field of the rotor penetrating the respective twisted straight section of the coil in a state, in which the coil is mounted in the electrical machine. The twist angle can be determined from a calculation and/or from a measurement of the magnetic field of the rotor. For the calculation and/or during the measurement, the influence of the magnetic material of a stator core of the electrical machine can be considered.

Afterwards, a plurality of windings is formed from the one or each tape-shaped conductor. Thereby, the windings can be formed in such manner, that each winding comprises two arc-shaped sections, and two straight sections, wherein at least one of the straight sections is twisted. Subsequently, the formed windings are arranged to form a coil, wherein the arc-shaped sections of the windings and the straight sections of the windings form the arc-shaped coil head sections and the straight sections of the coil. Accordingly, the torsion section of the one or each tape-shaped conductor forms the torsion sections of the coil.

In a second embodiment of the method for fabrication of a coil, it is possible that after the provision of one or more tape-shaped conductors, first a plurality of windings is formed from the one or each tape-shaped conductors, wherein each winding exhibits two arc-shaped sections and two straight sections, wherein afterwards a twisting of at least one of the straight sections occurs in at least two torsion sections of the one or each tape-shaped conductor, wherein the twisting angle of the twisting in the torsion sections of the one or each tape-shaped conductor is determined in dependence of a calculated and a measured magnetic field of the rotor. Afterwards, the windings are arranged forming a coil as described for the first embodiment.

In a third embodiment of the method, it is possible that after the provision of the one or more tape-shaped conductors, first a of a plurality of windings from the one or each tape-shaped conductor is formed, wherein each winding exhibits two arc-shaped sections and two straight sections. Afterwards, the formed windings are arranged to form a coil, wherein the arc-shaped sections of the one or each conductor form the arc-shaped coil head sections of the coil and wherein the straight sections of the conductors are forming the straight sections of the coil. Afterwards, one or both straight sections of the coil are twisted around the twist angle in at least two torsion sections of the coil, wherein the twist angle is determined in dependence of the calculated and/or measured magnetic field of the rotor. Hence in this embodiment, the twisting is implemented after the race-track coil has been formed.

By all three embodiments, a coil can be formed, which comprises at least one straight section, which is twisted around a twist angle, so that a coil mounted as a stator coil in the electrical machine has one or more conductors in its straight sections, which are aligned parallel or essentially parallel with their width direction to a magnetic field of the rotor of the electrical machine penetrating the respective straight section.

In an embodiment of a method according to embodiments of the invention, the windings can be fixed to each other during arranging of the windings or the windings may be fixed to each other after arranging of the windings. The windings can be fixed to each other during arranging of the windings for instance by providing an adhesive to the one or each conductor forming the windings, so that neighbouring windings are attached to each other by the adhesive. Alternatively, it is possible, that first the windings are arranged to each other and afterwards a fixing of the windings occurs by coating the arranged windings with an adhesive, for instance by immersing the arranged windings into a liquid adhesive.

The twisting of the one or each tape-shaped conductor occurs by tilting a rotational axis of a spool, on which the one or each tape-shaped conductor are wound up, during unwinding of the one or each tape-shaped conductor. This facilitates the twisting of the one or each tape-shaped conductor, since during the unwinding of the one or each tape-shaped conductor for forming the windings, the twist angle can be created by tilting the rotational axis of the roll, on which the one or each tape-shaped conductor is wound up.

In an embodiment of the invention, the twisting of the one or each tape-shaped conductor and the forming of the plurality of windings is conducted by winding the one or each conductor around a coil carrier element. The one or each conductor can be pressed against the coil carrier element during the formation of the or each winding, so that the one or each conductor adapts to shape of the coil carrier element. By this adaption, the arc-shaped coil head sections and the straight sections as well as the twisting of the conductor in the torsion sections can be formed.

All advantages and details described for the inventive electrical machine also apply to the inventive method for fabrication of a coil.

### BRIEF DESCRIPTION

Some of the embodiments will be described in detail, with reference to the following figures, wherein like designations denote like members, wherein:

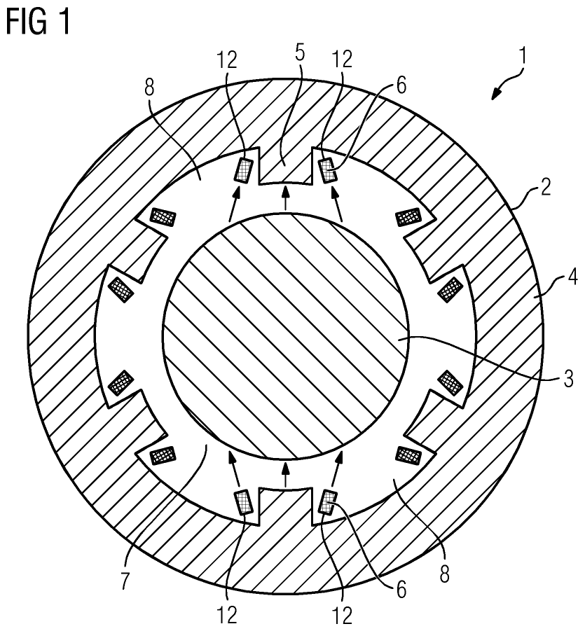

FIG. 1 shows a schematic sectional view on an electrical machine according to an embodiment of the invention;

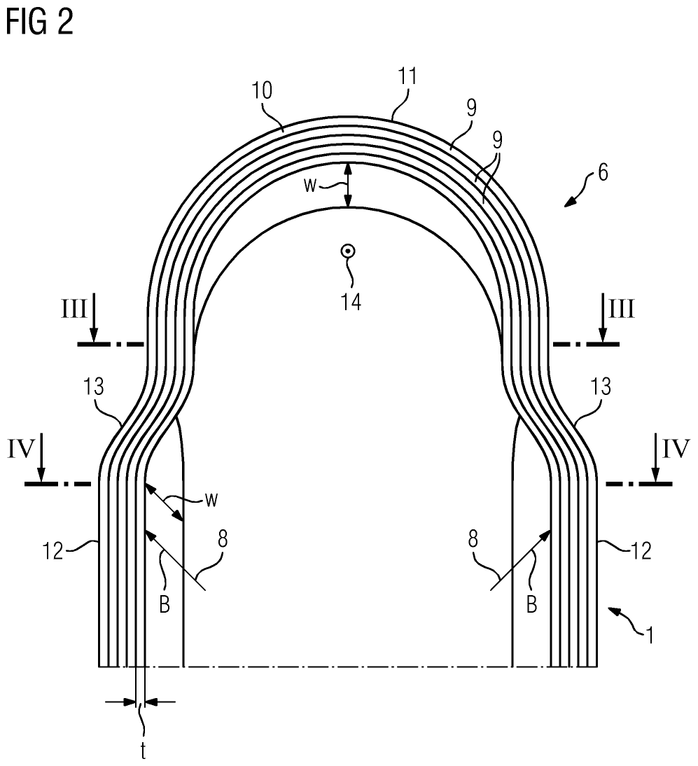

FIG. 2 shows a schematic view on a first embodiment of a coil of an electrical machine according to the invention;

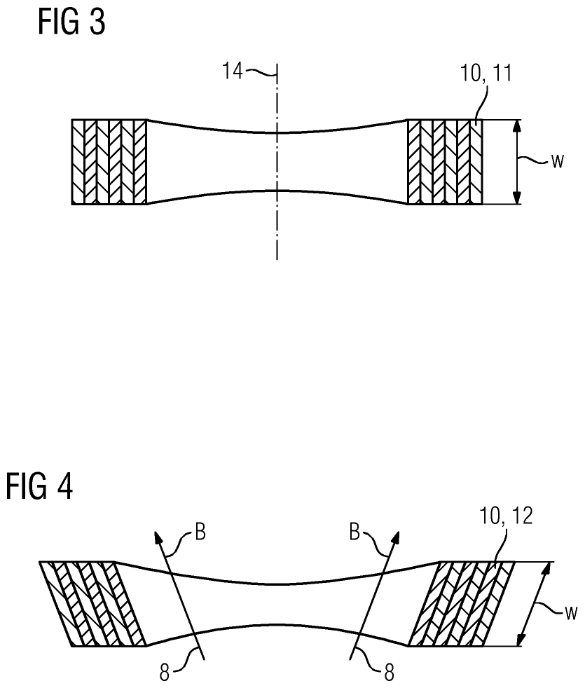

FIG. 3 shows a first sectional view of the first embodiment of the coil of an electrical machine according to the invention;

FIG. 4 a second sectional view of the first embodiment of the coil of the electrical machine according to the invention;

FIG. 5 a schematic top view of a second embodiment of a coil according to the invention;

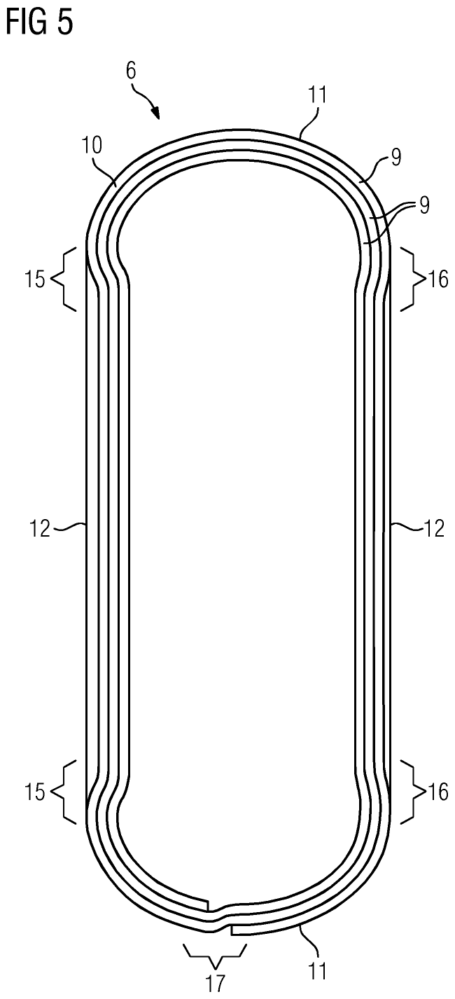

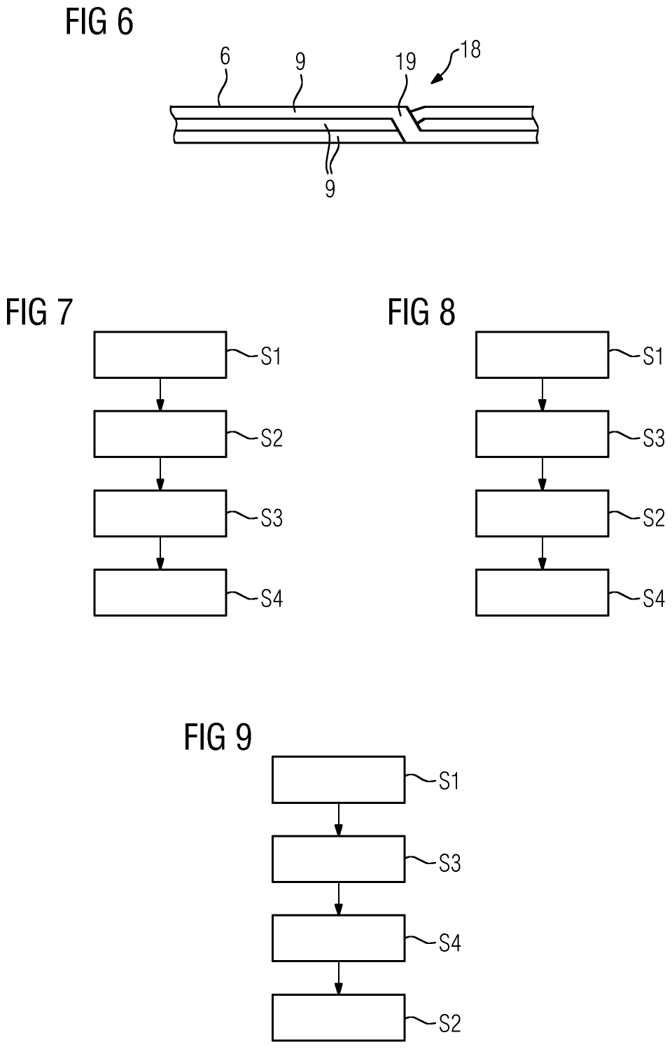

FIG. 6 a schematic side view on a transposition section;

FIG. 7 shows schematic flow diagrams of a first embodiment of a method according to the invention;

FIG. 8 shows a second embodiment of a method for fabrication of a coil; and

FIG. 9 shows a third embodiment of a method for fabrication of a coil is shown.

### DETAILED DESCRIPTION

In FIG. 1, a schematic sectional view of an electrical machine 1 according to embodiments of the invention is shown. The electrical machine 1 comprises a stator 2 and a rotor 3, wherein the rotor 3 is arranged inside the stator 2. The stator 2 comprises a stator core 4 exhibiting six poles 5, wherein around each pole a coil 6 is arranged. The stator 2 is separated from the rotor 3 by an air gap 7. The rotor 3 can generate a magnetic field expanding from the rotor 3 to the stator 2. The arrows 8 symbolize the magnitude and the direction of magnetic field lines of the magnetic field generated by the rotor 3. For reasons of clarity and comprehensibility, only the arrows 8 are shown, wherein the field lines of the magnetic field generated by the rotor 3 are omitted.

As it is indicated by the arrows 8, the magnetic field generated by the rotor 3 penetrates the coils 6. The course of the magnetic field lines or the directions of the arrows 8, respectively, is influenced by the material distribution and the shape of the stator 2, especially of the stator core 4 and/or the poles 5. In the vicinity of the coils 6 as well as inside the coils 6, the magnetic field generated by the rotor 3 is alternating during rotation of the rotor 3. During this rotation, the direction of the magnetic field in the vicinity of the coils 6 remains constant or almost constant, only the magnitude of the magnetic field varies between a value Bₘₐₓ and the value Bₘᵢₙ, wherein Bₘᵢₙ can be in particular -Bₘₐₓ. Therefore, the relation between the orientation of the coil 6 and the direction of the magnetic field remains also constant or almost constant during operation of the electrical machine 1.

The electrical machine 1 can be a synchronous machine. The rotor 3 of the electrical machine 1 can comprise at least one superconducting element, which is used for generation of the magnetic field. Also, the coil 6 of the stator 2 can be made of a superconducting material, as it will be described later. The electrical machine can comprise cooling means for cooling the stator 2 and/or the rotor 3 for maintaining the superconducting state of the superconducting coils 6 and/or the superconducting elements in the rotor 3, which are not shown in FIG. 1. As it is discernible from FIG. 1, each of the coils 6 comprises two straight sections 12 expanding in axial direction through the electrical machine 1, wherein a width direction of one or each conductor 10 forming the windings 9 of the coil 6 is aligned parallel to the direction of the magnetic field penetrating the respective straight sections 12 as indicated by the arrows 8.

In FIG. 2, a detailed view on a coil 6 is shown. In FIG. 2, only a half-coil is depicted, wherein the second half, which is not depicted, exhibits the same geometry as the shown half coil. The coil 6 comprises six windings 9 made from one or more tape-shaped conductors 10. It is possible, that one tape-shaped conductor 10 is wound around itself forming a plurality of windings 9. It is also possible that each winding is made from one tape-shaped conductor 10, wherein the plurality of conductors 10 or each winding, respectively, is electrically connected to each other forming the coil 6. It is also possible that each winding 9 is made from a plurality of stacked conductors 10 connected in parallel.

The or each conductor 10 comprises a tape-shaped geometry and has a width w and thickness t. The or each conductor 10 can be made of a superconducting material, for instance of a tape-shaped superconductor of the second generation comprising a superconducting layer made of YBaCuO. The superconducting part of the tape-shaped conductor may exhibit a thickness, which is about three orders of magnitudes smaller than its width. For instance, the width can be several millimetres, for instance between 4 mm and 40 mm. The thickness of the superconducting layer of the conductor 10 can be for instance between 1 and 2 μm. Besides the superconducting layer, the conductor 10 may comprise also a carrier layer like a metal substrate on which the superconducting layer is arranged and/or an insulation coating. Alternatively, it is possible that the conductor comprises superconducting filaments, in particular filaments made of BiSrCaCuO, or that the conductor comprises a layer and/or at least one strand of MgB₂ and/or MbTi and/or Mb₃Sm.

In the depicted coil 6, the windings 9 of the tape-shaped conductor 10 abut each other. Alternatively, it is possible, that between each winding 9, an insulating layer is arranged. The coil 6 can have more or less than six windings 9, it is in particular possible that it comprises between 20 and 200 windings.

The coil 6 has a race-track shape and comprises two coil head sections 11, wherein the second coil head section 11 on the other half of the coil is not depicted in FIG. 2. The coil 6 also comprises two straight sections 12 as well as four torsion sections 13, which are arranged each in between one of the straight sections 12 and one of the coil head sections 11. From the four torsion sections 13, two torsion sections 13 are shown between the depicted coil head section 11 and the portions of the two straight sections 12.

In the coil head sections 11, the conductors 10 are arranged in such manner, that the width direction of the conductors 10 is parallel to a bending axis 14 of the arc-shaped coil head sections 11. The width direction of the conductors 10 is orthogonal to a longitudinal axis of each of the conductors 10 and to a thickness direction of each of the conductors 10. In the torsion sections 13, the windings 9 are twisted around the longitudinal axis of the or each conductor, wherein the orientation of the width direction changes. The orientation of the width direction changes in the torsion sections from the alignment parallel to the axis of the coil head to an alignment parallel to the direction of the respective magnetic field B, as indicated by the arrows 8, which penetrates the respective straight sections.

It is discernible in FIG. 2, that in the straight sections 12, the width direction of the conductors of the windings in the respective straight sections 12 are aligned parallel or almost parallel to the direction of the magnetic field penetrating the respective straight section 12 as indicated by the arrows 8. By this parallel alignment of the width direction, the occurrence of losses, which are generated due to the varying amplitude of the magnetic field, are reduced since the area of the conductors, which is aligned orthogonal to the magnetic field, is determined by the thickness of the conductors 10 and not by their width.

The orientation of the conductors 10 towards the bending axis 14 in the coil head sections 11 can be seen in FIG. 3, which shows the sectional view through the cutting plane III-III'. It is discernible, that in the coil head sections 11, the width direction of the conductors 10 are parallel to the bending axis 14. Due to the twist of the windings in the torsion sections 13 in between the coil head sections 11 and the straight sections 12, the width direction of the conductors 10 is aligned parallel to the magnetic field B in the straight sections 12. This can be seen in FIG. 4, which shows the sectional view of the cutting plane IV-IV′ of FIG. 2. The alignment of the width direction of the conductors 10 is parallel to the direction of the magnetic field as symbolized by the arrows 8.

In FIG. 5, a second embodiment of a coil 6 according to embodiments of the invention is shown. The coil 6 comprises a race-track shape formed by the two arc-shaped coil head sections 11 and the two straight sections 12. In between the straight sections 12 and the coil head sections 11, four torsion sections 15, 16 are arranged, in which the windings 9 of the coil 6 are twisted around a longitudinal axis of the conductors 10. In this embodiment, the twisting angles of the torsion sections 15 is different from the twisting angle of the torsion section 16. In the torsion sections 15, the twisting angle is larger and the windings 9 of the straight section 12 in between the torsion sections 15 are twisted in a clockwise direction. Contrary, in the torsion section 16, the twisting angle is smaller and the windings 9 of the straight section 12 in between the torsion sections 16 are twisted in an anti-clockwise direction.

By using two different twisting angles in the torsion sections 15 and 16, an adaption of the orientation of the conductors 10 in each straight section 12 to the orientation of the magnetic field penetrating the respective straight section 12 is possible. In this embodiment, the windings 9 are formed by one single tape-shaped conductor 10, which is wound three times to form three windings 9. These three windings 9 are connected to each other in a connection section 17 located inside one of the coil head sections 11. It is also possible, that the connection section 17 is located inside one of the straight sections 12 or inside one of the torsion sections 15 or 16, respectively.

It is also possible, that the coil 6 comprises one or more transposition sections 18 as shown in FIG. 6. In the transposition section 18, a first winding 19 changes its position from a top position to a bottom position, so that the stacking order of the windings 9 of the coil 6 are changed. By cyclically changing the stacking order of in particular all of the windings, coupling currents between the windings 9 and losses related to the conduction of alternating current can be reduced. A coil 6 can have one or more transposition sections 18, which can be located each in one of the coil head sections 11, one of the straight sections 12 and/or one of the torsion sections 13, 15, 16. Additionally or alternatively, it is possible that one or more of the windings 9 of the coil 6 are formed from a plurality of stacked conductors 10, wherein at least a part of the stacked conductors 10 are transposed and/or wherein the stacked conductors 10 are forming a Roebel conductor.

In FIGS. 7 to 9, three embodiments of a method for fabrication of a coil of an electrical machine according to embodiments of the invention are shown. The methods each comprise the steps:

S1 Providing one or more tape-shaped conductors 10.
S2 Twisting of the one or each tape-shaped conductor 10, wherein a twist angle is determined in dependence of a calculated and/or a measured magnetic field of the rotor 3.
S3 Forming of a plurality of windings 9 from one or each tape-shaped conductor 10.
S4 Arranging of the windings 9 forming a coil 6.

In the first embodiment depicted in FIG. 1, first one or more tape-shaped conductors are provided in step S1. Afterwards in step S2, the one or each tape-shaped conductor 10 is twisted in at least two torsion sections of the conductor 10, wherein a twist angle is determined in dependence of a calculated and/or a measured magnetic field of the rotor 3. Since for a given electrical machine 1, the geometry of the rotor 3 and the stator 2, in particular of the stator coil 4, is known, the calculation of the magnetic field distribution in the area of the coil 6 is possible. Additionally or alternatively, a measurement of the magnetic field in the area of the coil 6 is possible. By the twisting of the one or each conductor 10, the orientation of a width direction of the one or each conductor 10 in the straight section 12 is adapted to the respective calculated and/or measured magnetic field, so that the width direction of the or each conductor 10 is aligned parallel or essentially parallel to the magnetic field penetrating the respective straight section 12.

Afterwards, in step S3, a plurality of windings 9 is formed from the one or each tape-shaped conductor 10 wherein each winding 9 comprises an arc-shaped section and a straight section. In step S4, the windings 9 are arranged forming a coil 6, wherein the arc-shaped sections of the windings 9 form an arc-shaped coil head section 11 of the coil 6 and wherein the straight sections of the windings 9 are forming the straight sections 12 of the coil 6. Accordingly, the torsion sections of the or each conductor are forming the torsion sections 13, 15, 16 of the coil.

A second embodiment of a method for fabrication of a coil is shown in FIG. 8. As a first step S1, one or more tape-shaped conductors 10 are provided. Subsequently, in step S3, from the one or each conductor 10, a plurality of windings 9 is formed, wherein each winding 9 comprises two arc-shaped sections and two straight sections. After forming of the windings, in step S2, each winding 9 is twisted in a torsion section around a twisting angle, wherein the twisting angle is determined in dependence of a calculated and/or measured magnetic field of the rotor 3. Afterwards, in step S4, the windings are arranged forming a coil 6 as previously described.

In FIG. 9, a third embodiment of a method for fabrication of a coil 6 is shown. After provision of one or more tape-shaped conductors 10 in step S1, a plurality of windings 9 is formed from the one or each tape-shaped conductor 10, wherein each winding 9 exhibits two opposing arc-shaped sections and two opposing straight sections. In subsequent step S4, the windings 9 are arranged forming a coil 6, so that the coil 6 exhibits two arc-shaped coil head sections 11 and two straight sections 12. Subsequently, in step S2, the windings 9 are twisted in at least two torsion sections 13, wherein the respective twisting angle is determined in dependence of a calculated and/or a measured magnetic field of the rotor 3.

For each of the three embodiments, a coil comprising two opposing arc-shaped coil head sections 11, two opposing straight sections 12 and at least two torsion sections 13, 15, 16 can be fabricated. In each of the three embodiments, the fixation of the windings 9 to each other may occur during arranging of the windings 9, for instance by applying an adhesive to the conductor 12 forming the windings 9. Alternatively, a fixing of the windings 9 can occur after arranging of the windings 9, hence when the coil 6 has been formed from the windings 9, wherein the fixing can occur for instance by immersing the coil 6 into a liquid adhesive.

In each of the three embodiments, the twisting of the one or each tape-shaped conductor 10 can occur by tilting a rotational axis of a spool, on which the one or each tape-shaped conductor 10 is wound up, wherein the tilting of the rotational axis occurs for instance during unwinding of the one or each tape-shaped conductor 10. By tilting the rotational axis of the spool carrying the tape-shaped conductor 10, the twisting of the one or each tape-shaped conductor 10 can occur directly during unwinding of the one or each tape-shaped conductor 10 forming the windings 9.

Alternatively, it is possible, that the twisting of the tape of the one or each tape-shaped conductor 12 as well as the forming of the windings 9 occurs by winding the one or each tape-shaped conductor 10 around a coil carrier element. By winding the one or each tape-shaped conductor 10 around the coil carrier element, both the arc-shaped coil head sections 11 and the straight sections 12 of the coil 6 can be formed as well as the twisting of the windings 9 in the respective torsion sections 13, 15, 16 can be obtained.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. An electrical machine comprising a rotor and a stator with at least one coil, wherein the coil comprises one or more windings of one or more tape-shaped conductors, wherein the or each conductor has a longitudinal axis, wherein the coil comprises two opposing straight sections and two opposing arc-shaped coil head sections, wherein the coil comprises at least two torsion sections, in which the or each winding is twisted around the longitudinal axis of the or each conductor, so that a width direction of the one or each conductors in at least one of the straight sections is parallel or essentially parallel to a direction of a magnetic field generated or generatable by the rotor penetrating the at least one straight section.

2. The electrical machine according to claim 1, wherein the coil comprises four torsion sections, which are each arranged between one of the coil head sections and one of the straight sections.

3. The electrical machine according to claim 1, wherein the width direction of the or each tape-shaped conductor in the coil head sections is parallel or essentially parallel to a bending axis of the respective coil head section.

4. The electrical machine according to claim 1, wherein a twist angle in each torsion section is ±90° or less.

5. The electrical machine according to claim 1, wherein the coil comprises a plurality of windings, wherein each winding abuts at least one neighbouring winding or wherein an insulating layer is disposed between two neighbouring windings.

6. The electrical machine according to claim 1, wherein the coil comprises a plurality of windings and at least one transposition section, in which a stacking order of the windings is changed.

7. The electrical machine according to claim 1, wherein the or each conductor is a superconductor, of either a high-temperature superconductor of the first generation or the second generation.

8. The electrical machine according to claim 7, wherein the or each conductor is a coated conductor comprising a coating layer and a superconducting layer, in particular a superconducting layer made of YBaCuO, or that the conductor comprises superconducting filaments, in particular filaments made of BiSrCaCuO, or that the conductor comprises a layer and/or at least one strand of MgB₂ and/or NbTi and/or Nb₃Sn.

9. The electrical machine no according to claim 1, wherein the rotor comprises at least one superconducting element, especially a superconducting element for the generation of the magnetic field.

10. The electrical machine according to claim 1, wherein the electrical machine is a synchronous machine or an induction machine.)

11. A method for fabrication of a coil of the electrical machine according to claim 1, comprising the steps:
a) providing one or more tape-shaped conductors
b) twisting of the one or each tape-shaped conductor, wherein a twist angle is determined in dependence of a calculated and/or a measured magnetic field of the rotor,
c) forming of a plurality of windings from the one or each tape-shaped conductor,
d) arranging of the windings, forming a coil,
wherein the steps are conducted in the order a), b), c), d), or a), c), b) d), or a), c), d), b).

12. The method according to claim 11, wherein the windings are fixed to each other during arranging of the windings or that the windings are fixed to each other after arranging of the windings.

13. The method according to claim 11, wherein the twisting of the one or each tape-shaped conductor occurs by tilting a rotational axis of a spool, on which the one or each tape-shaped conductor is wound up, during unwinding of the one or each tape-shaped conductor.

14. The method according to claim 11, wherein the twisting of the one or each tape-shaped conductor and the forming of the plurality of windings is conducted by winding the one or more tape-shaped conductor around a coil carrier element.
